(19) United States
(12) Patent Application Publication
(10) Pub. No.: US 2009/0247680 A1
(43) Pub. Date: Oct. 1, 2009

(54) ADHESION PROMOTING ADDITIVE

(75) Inventor: James T. Hayes, Glens Falls, NY (US)

Correspondence Address: Avery Dennison Corporation;Amanda Wittine, 8080 Norton Parkway, 22-D, Mentor, OH, 44060, US

(73) Assignee: AVERY DENNISON CORPORATION, Pasadena, CA (US)

(21) Appl. No.: 12/303,152

(22) PCT Filed: May 31, 2007
(86) PCT No.: PCT/US07/70056

§ 371 Date: Dec. 2, 2008

Related U.S. Application Data
(60) Provisional application No. 60/811,257, filed on Jun. 6, 2006.

(51) Int. Cl. C09D 183/04

(52) U.S. Cl. 524/314; 524/588; 524/379

(57) ABSTRACT

A release coating additive for a release coating that provides adhesion to polymeric films and that has improved storage stability is provided. Also provided is a release liner having a release coating on a polyester substrate wherein the release coating composition comprises an adhesion promoting additive having improved storage stability.

This application claims the benefit of U.S. Provisional Application No. 60/811,247 filed Jun. 6, 2006, the contents of which are hereby incorporated by reference in their entirety.

### TECHNICAL FIELD

The present invention relates to an improved adhesion promoting additive for use in silicone release coating compositions, and in particular, to an adhesion promoting additive having improved storage stability.

### BACKGROUND

Thermally curable silicone compositions are applied to substrates to facilitate in the release of adhesive materials thereon. Laminate constructions comprising a release coated polymeric film with a pressure sensitive adhesive and a sheet material that can be a label or decorative lamina are used by stripping off the release liner and affixing the lamina or label onto a surface.

The thermally curable release compositions generally comprise (a) an alkenyl substituted polysiloxane (b) a hydride functional crosslinking silicone, such as a methyl hydrogen siloxane polymer, copolymer or oligomer, (c) a hydrosilylation catalyst, such as a platinum or rhodium based catalyst, and (d) a hydrosilylation inhibitor.

Adhesion promoting additives may be added to the release composition to improve the adhesion of the release coating to polymeric films, and in particular, to polyester films. Adhesion promoters for silicone release compositions often comprise polysiloxanes.

It has been found that polysiloxane adhesion promoters can be unstable, particularly when stored over relatively long periods of time or when exposed to the atmosphere over relatively shorter periods of time. The viscosity of the adhesion promoting additive can increase to levels such that the additive becomes unusable. In addition, the evolution of hydrogen gas within the sealed container may become a safety issue.

### SUMMARY

The present invention provides for a release coating additive for a release coating that provides adhesion to polymeric films and that has improved storage stability. The adhesion promoting additive comprises (a) a polysiloxane having the formula (RₐSiO_{(4-a)/2})ₙ where n is an integer greater than 3, a is from 1 to 3, R is an epoxide containing radical having from one to forty carbon atoms, monovalent hydrocarbon or hydrocarbonoxy radicals, hydride atoms, and with at least one epoxide and hydride being present on the molecule; and (b) an inhibitor.

The present invention further provides a release liner comprising a polyester substrate and a silicone release coating on the polyester substrate. The silicone release liner comprises an adhesion promoting additive comprising (a) a polysiloxane having the formula (RₐSiO_{(4-a)/2})ₙ where n is an integer greater than 3, a is from 1 to 3, R is an epoxide containing radical having from one to forty carbon atoms, monovalent hydrocarbon or hydrocarbonoxy radicals, hydride atoms, and with at least one epoxide and hydride being present on the molecule; and (b) an inhibitor.

A method for making an adhesion promoting additive for release coatings having improved storage stability is provided. The method comprises (a) providing a polysiloxane having the formula (RₐSiO_{(4-a)/2})ₙ where n is an integer greater than 3, a is from 1 to 3, R is an epoxide containing radical having from one to forty carbon atoms, monovalent hydrocarbon or hydrocarbonoxy radicals, hydride atoms, and with at least one epoxide and hydride being present on the molecule; and (b) adding an inhibitor to the polysiloxane.

### DETAILED DESCRIPTION

The adhesion promoting additive of the present invention comprises a) a polysiloxane having the formula (RₐSiO_{(4-a)/2})ₙ where n is an integer greater than 3, a is from 1 to 3, R is an epoxide containing radical having from one to forty carbon atoms, monovalent hydrocarbon or hydrocarbonoxy radicals, hydride atoms, and with at least one epoxide and hydride being present on the molecule; and (b) an inhibitor.

In one embodiment, the adhesion promoting additive contains an epoxy functional silane selected from at least one of epoxycyclohexylethyl trimethoxysilane; γ-glycidoxypropyl trimethoxysilane; γ-glycidoxypropyl triethoxysilane; γ-glycidoxypropyl methyldimethoxysilane; and γ-glycidoxypropyl methyldiethoxysilane.

Inhibitors are well known in the organosilicon art. Examples of various classes of such metal catalyst inhibitors include unsaturated organic compounds such as ethylenically or aromatically unsaturated amides; acetylenic compounds; ethylenically unsaturated isocyanates; olefinic siloxanes; unsaturated hydrocarbon diesters; and conjugated ene-ynes; other organic compounds such as hydroperoxides; ketones; sulfoxides; amines; phosphines; phosphites; nitrites; diaziridines; half esters and half amides; and various salts. It is believed that the compositions of this invention can comprise an inhibitor from any of these classes of inhibitors.

Unsaturated amide inhibitors include those having the structural formula

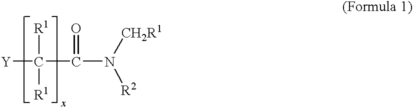

wherein R¹ is independently selected from —CH═CH₂, phenyl, —H, an alkyl group having 1 to 4 carbon atoms, or naphthyl; R² is CH₂R¹, or allyl; Y is aryl or

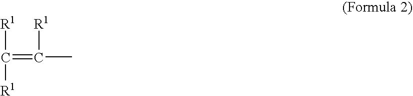

x is 0 or 1; with the proviso that at least one of R¹ and R² is ethylenically or aromatically unsaturated. Such amide inhibitors are described in U.S. Pat. No. 4,337,332.

Useful acetylenic inhibitors include mono and di-alkynyl substituted derivatives of maleic acid having the formula:

R₁O₂C—CH═CH—CO₂R₂

wherein R₁ has the formula:

—R₃—C≡C—R₄

wherein R₃ is selected from the group of divalent hydrocarbon radicals consisting of linear or branched alkyl radicals having from 1 to about 10 carbon atoms, linear or branched alkenyl radicals having from 1 to about 10 carbon atoms, linear or branched alkynyl radicals having from 1 to about 10 carbon atoms, cycloalkyl radicals having from 3 to about 12 carbon atoms, cycloalkenyl radicals having from about 3 to 12 carbon atoms, cycloalkynyl radicals having from about 8 to about 16 carbon atoms, fluorinated linear or branched alkyl radicals having from 1 to about 10 carbon atoms, chlorinated linear or branched alkyl radicals having from 1 to about 10 carbon atoms, brominated linear or branched alkyl radicals having from 1 to about 10 carbon atoms, fluorinated linear or branched alkenyl radicals having from 1 to about 10 carbon atoms, chlorinated linear or branched alkenyl radicals having from 1 to about 10 carbon atoms, brominated linear or branched alkenyl radicals having from 1 to about 10 carbon atoms, fluorinated linear or branched alkynyl radicals having from 1 to about 10 carbon atoms, chlorinated linear or branched alkynyl radicals having from 1 to about 10 carbon atoms, brominated linear or branched alkynyl radicals having from 1 to about 10 carbon atoms, hydrocarbonoxy radicals containing at least two carbon atoms, fluorinated hydrocarbonoxy radicals containing at least two carbon atoms, chlorinated hydrocarbonoxy radicals containing at least two carbon atoms, brominated hydrocarbonoxy radicals containing at least two carbon atoms, aryl radicals, linear or branched alkyl aryl radicals, fluorinated aryl radicals, chlorinated aryl radicals, brominated aryl radicals; fluorinated linear or branched alkyl-, alkenyl-, or alkynyl aryl radicals; chlorinated linear or branched alkyl-, alkenyl-, or alkynyl aryl radicals; and brominated linear or branched alkyl-, alkenyl-, or alkynyl aryl radicals; and wherein R₄ is selected from the group of monovalent radicals consisting of hydrogen, linear or branched alkyl radicals having from 1 to about 10 carbon atoms, linear or branched alkenyl radicals having from 1 to about 10 carbon atoms, linear or branched alkynyl radicals having from 1 to about 10 carbon atoms, cycloalkyl radicals having from 3 to about 12 carbon atoms, cycloalkenyl radicals having from about 3 to 12 carbon atoms, cycloalkynyl radicals having from about 8 to about 16 carbon atoms, fluorinated linear or branched alkyl radicals having from 1 to about 10 carbon atoms, chlorinated linear or branched alkyl radicals having from 1 to about 10 carbon atoms, brominated linear or branched alkyl radicals having from 1 to about 10 carbon atoms, fluorinated linear or branched alkenyl radicals having from 1 to about 10 carbon atoms, chlorinated linear or branched alkenyl radicals having from 1 to about 10 carbon atoms, brominated linear or branched alkenyl radicals having from 1 to about 10 carbon atoms, fluorinated linear or branched alkynyl radicals having from 1 to about 10 carbon atoms, chlorinated linear or branched alkynyl radicals having from 1 to about 10 carbon atoms, brominated linear or branched alkynyl radicals having from 1 to about 10 carbon atoms, hydrocarbonoxy radicals containing at least two carbon atoms, fluorinated hydrocarbonoxy radicals containing at least two carbon atoms, chlorinated hydrocarbonoxy radicals containing at least two carbon atoms, brominated hydrocarbonoxy radicals containing at least two carbon atoms aryl radicals, linear or branched alkyl aryl radicals, fluorinated aryl radicals, chlorinated aryl radicals, brominated aryl radicals; fluorinated linear or branched alkyl-, alkenyl-, or alkynyl aryl radicals; chlorinated linear or branched alkyl-, alkenyl-, or alkynyl aryl radicals; brominated linear or branched alkyl-, alkenyl-, or alkynyl aryl radicals; and triorganosilyl radicals and wherein R₂ may be R₁ or selected from the group consisting of hydrogen, triorganosilyl radicals, and siloxanes wherein the structural geometry of the compound around the double bond may be either cis or trans. Such acetylenic compounds are described in U.S. Pat. No. 5,506,289.

Additional acetylenic compounds are those described in U.S. Pat. No. 4,347,346, and include dialkylacetylenedicarboxylates that result from the diesterification reaction of 2-butynoic dicarboxylic acid with two equivalents of alcohols such as methanol, ethanol, butanol, benzylic alcohol, allyl alcohol or mixtures of such alcohols. Useful diesters prepared in this fashion include dimethylacetylenedicarboxylate, diethylenedicarboxylate, dibuty-acetylenedicarboxylate, methylbutylacetylenedicarboxylate, methylethylacetylenedicarboxylate, etc.

Acetylenic compounds useful as inhibitors include those compounds described in U.S. Pat. No. 3,445,420, e.g.:

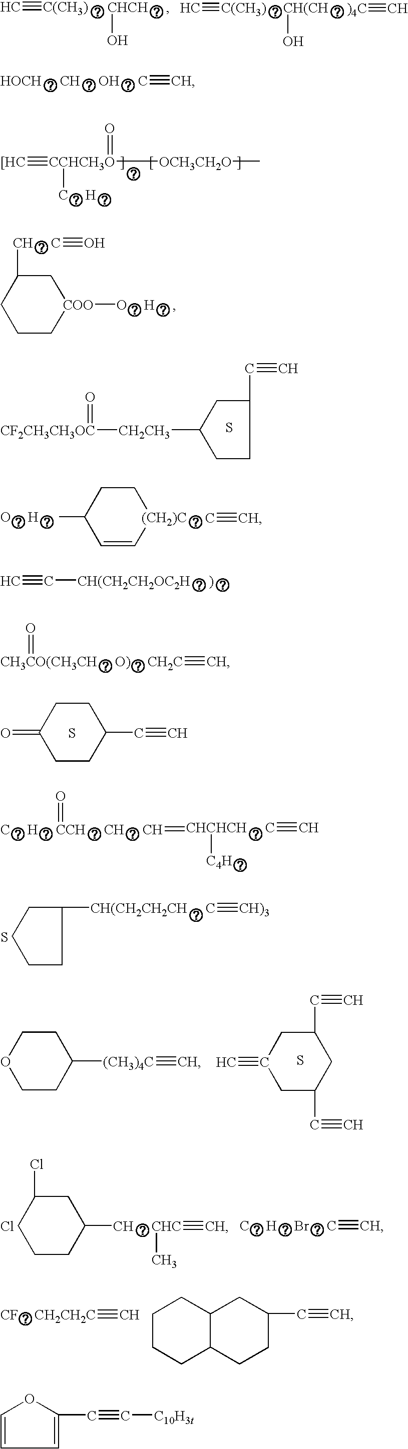

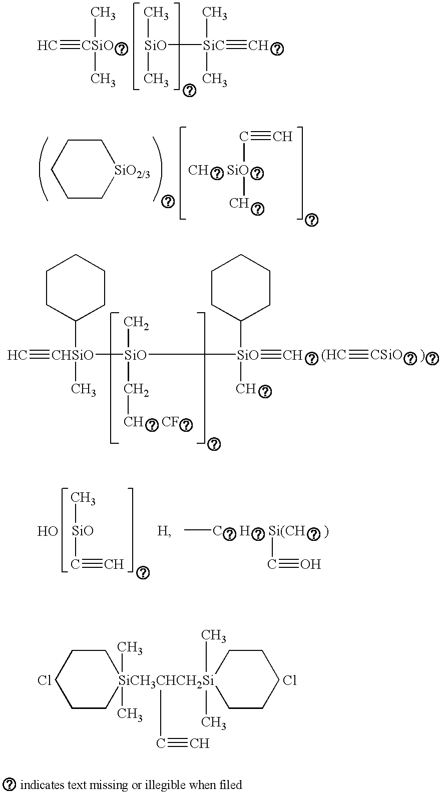

Ethylenically unsaturated isocyanate inhibitors include those having the structural formula:

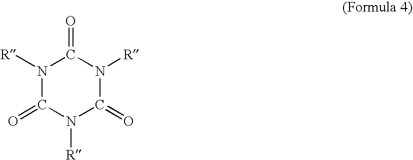

wherein R″ is the same or different and is selected from the group consisting of hydrogen, lower alkyl, aryl, aralkyl, polynuclear aryl, heteroaryl, monofunctional lower-alkenyl and substituted derivatives thereof, with the proviso that at least one R″ is monofunctional lower-alkenyl. Such isocyanates are described in U.S. Pat. No. 3,882,083.

Olefinic siloxane inhibitors include polyorganosiloxanes consisting essentially of from 3 to 10 siloxane units in which (a) at least one siloxane unit is selected from the group consisting of RHSiO and R₂HSiO_{0.5} and (b) at least one siloxane unit is selected from the group consisting of

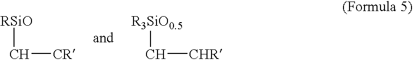

where the sum of siloxane units in (a) and (b) is equal to at least three siloxane units, and (c) any remaining siloxane units being selected from the group consisting of R₃SiO_{0.5}, SiO₂ and RSiO_{1.5} where each siloxane unit of (c) does not exceed three siloxane units, where R is a monovalent radical selected from the group consisting of hydrocarbon radicals and perfluoroalkylethylene radical, both having no more than six carbon atoms and R′ is a monovalent hydrocarbon radical having a secondary or tertiary hydroxy substitution and having no more than ten carbon atoms. Such olefinic siloxane inhibitors are described in U.S. Pat. No. 3,989,667.

Useful unsaturated hydrocarbon diester inhibitors include, for example, diallyl maleate. Other diallylic carboxylic esters include diallyphthalate and diallylsuccinate. Also, saturated dialkyl esters of maleic acid, such as diethyl and dimethyl maleate and mixed esters such as butylallyl maleate or methyl ethyl maleate are useful inhibitors. Silylmaleates, such as bis-γ-propyltris(methyoxy) silylmaleate, may also be used. Hydrocarbonoxyalkyl maleates having the formula

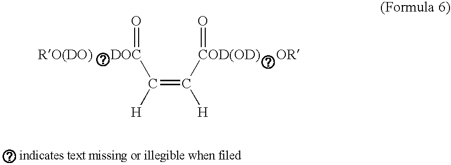

wherein each R′ denotes, independently, a monovalent hydrocarbon radical having from 1 to 6 carbon atoms, each D denotes, independently, an alkylene radical having from 2 to 4 carbon atoms and each a has an average value of from 0 to about 5 are described in U.S. Pat. No. 4,562,096.

Useful conjugated ene-yne inhibitors include those having the structural formula

HC═C—CR⁴═CR⁵R⁶

wherein R⁴, R⁵ and R⁶ each denote, independently, a hydrogen atom, a monovalent hydrocarbon group or a divalent hydrocarbon group with the requirement that the total number of carbon atoms in these groups range from 2 to 6. Such inhibitors are described in U.S. Pat. No. 4,465,818. Examples of the monovalent hydrocarbon groups R⁴, R⁵ and R⁶ include groups such as methyl, ethyl and propyl groups; however, aryl groups such as the phenyl group may also be used. Examples of unsaturated hydrocarbons having monovalent hydrocarbon groups include 3-methyl-3-pentene-1-yne; 3-methyl-3-hexene-1-yne; 3,5-dimethyl-3-hexene-1-yne; and 3-phenyl-3-butene-1-yne. Examples of divalent hydrocarbon groups R⁴, R⁵ and R⁶ include —CH₂—, —CH₂CH₂—, —CH₂CH₂CH₂—, —CH₂CH(CH₃)CH₂—, —CH₂C(CH₃)₂CH₂—, and —CH₂CH(CH₃)CH₂CH₂—. Examples that containing divalent hydrocarbon groups which are bonded together by their second valence include

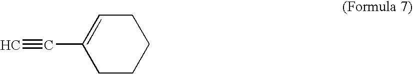

which may be alternatively considered as containing two —CH₂CH₂— groups or one —CH₂— group and one —CH₂CH₂CH₂— group for R⁴ and R⁵. Other examples include

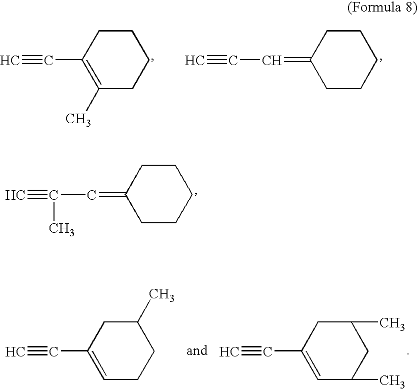

Useful hydroperoxy inhibitors include those described in U.S. Pat. No. 4,061,609. The hydroperoxy containing compound can have any desired structure as long as it contains a hydroperoxy radical in the molecular structure because it is such hydroperoxy radical that accomplishes the inhibiting activity. Other hydroperoxy inhibitor compounds that may be utilized in the instant invention are, for instance, methylethylketone peroxides, cumene hydroperoxide, 1,1,3,3-tetramethylbutylhydroperoxide and 2,5-dimethyl-2,5-dihydroperoxy hexane. Other compounds that may be utilized are methylethylketone peroxide, cumene hydroperoxide, t-butyl hydroperoxide, 1-hydroxycyclohexyl hydroperoxide, 1,1,3,3-tetramethylbutyl hydroperoxide, 2,5-dimethyl-2,5-dihydroperoxy hexane, decalin hydroperoxide, 1,1,2,2-tetramethylpropyl hydroperoxide, p-methane hydroperoxide and pinane hydroperoxide.

Ketone inhibitors include those having the general formula

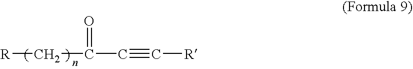

in which n is an integer ranging from 0 to 10, preferably ranging from 1 to 5, R is a linear or branched chain alkyl radical having from 1 to 10 carbon atoms, an alkenyl radical having from 2 to 4 carbon atoms, a phenyl radical, a cycloalkyl radical having from 4 to 8 carbon atoms, an organosilyl radical selected from among the trialkylsilyl and trialkoxysilyl radicals in which the alkyl moiety has from 1 to 4 carbon atoms or a halogen atom selected from among chlorine, bromine and iodine, and R′ is a hydrogen atom, an alkyl radical having from 1 to 4 carbon atoms, an α-hydroxyalkyl radical having from 1 to 4 carbon atoms, an alkylcarbonyl radical in which the alkyl moiety contains from 1 to 6 carbon atoms, a benzoyl radical, a benzoylalkyl radical in which the alkyl moiety contains from 1 to 6 carbon atoms, and an organosilyl radical selected from among the trialkylsilyl and trialkoxysilyl radicals in which the alkyl moiety has from 1 to 4 carbon atoms. Such inhibitors are described in U.S. Pat. No. 4,595,739 and include 1-octyne-3-one; 8-chloro-1-octyn-3-one; 2-hydroxy-3-hexyn-5-one; 8-bromo-1-ocryn-3-one; 4,4-dimethyl-1-octyn-3-one; 7-chloro-1-heptyn-3-one; 1-chloro-7-dodecyn-6-one; 1-acetyl-1-n-octyne; 1-phenyl-1-butyn-3-one; 3-hexyn-3-one; 1-pentyn-3-one; 4-methyl-1-pentyn-3-one; 4,4-dimethyl-1-pentyn-3-one; 1-cyclohexyl-1-prppyn-3-one; 1-hexen-5-yn-4-one; benzoylacetylene; 0-chlorobenzoyl-acetylene; p-methoxybenzoyl-acetylene; 1-trimethylsilyl-1-butyn-3-one; 1-trimethylsilyl-4,4-dimethyl-1-pentyn-3-one and 1-trimethylsilyl-2-benzoylacetylene.

Useful diaziridine inhibitors are described in U.S. Pat. No. 4,043,977 and include those having the formula

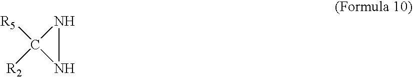

wherein R₁ and R₂ represent a radical that contains up to 6 C atoms and wherein R₁ and R₂ can together form a ring system. Examples include dimethyl diaziridine, methylethyl diaziridine, diethyl diaziridine, methylisopropyl diaziridine, methylpropyl diaziridine, dipropyl diaziridine, pentamethylene diaziridine and hexamethylene diaziridine.

Half ester and half amide inhibitors are described in U.S. Pat. No. 4,533,575 and include those having the structural formula

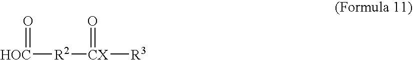

wherein R² is ethynylene (—C≡C—) or cis-ethenylene —CH═CH—; R³ is a saturated or unsaturated organic group having 1 to 12 carbon atoms which can be unsubstituted or substituted by 1 to 23 halogen atoms, and has up to 25 hydrogen atoms, and 0 to 5 non-peroxidic catenary oxygen atoms, and preferably R³ is selected from organic groups consisting of (1) acyclic straight-chain saturated and unsaturated aliphatic groups having 1 to 12 carbon atoms, (2) saturated and unsaturated alicyclic groups having 3 to 12 carbon atoms, (3) aryl groups having 6 to 12 carbon atoms, (4) alkaryl and aralkyl groups having 7 to 12 carbon atoms, (5) alkenylaryl and aralkenylene groups having 8 to 12 carbon atoms, and (6) alkoxyalkyl and poly(alkoxy)alkyl groups in which the alkyl groups have 2 to 4 carbon atoms and having a total of 4 to 12 carbons in the alkoxyalkyl and poly(alkoxy)alkyl groups; and X is —O— or

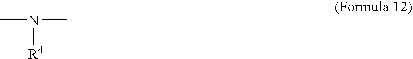

in which R⁴ is the same as defined for R³, and R³ and R⁴ together can be alkylene, which with the N, can form a saturated 5- or 6-atom membered azacyclic ring, and preferably X is —O—.

Monoesters or monoamides may be prepared by reaction of one mole of maleic anhydride or acetylenedicarboxylic acid with one mole of an amine, R³—NH—R⁴, in which in which R³ and R⁴ are as defined for formula 11. Examples of monohydrogen esters are methyl hydrogen, maleate, ethyl hydrogen maleate, 2-fluoroethyl hydrogen maleate, 2,2,2-trifluoroethyl hydrogen maleate, 1,1-dihydroperfluoropropyl hydrogen maleate, 1,1-dihydroperfluorooctyl hydrogen maleate, 1,1-dihydroperfluorododecyl hydrogen maleate, butyl hydrogen maleate, hexyl hydrogen maleate, dodecyl hydrogen maleate, isopropyl hydrogen maleate, 2-ethylhexyl hydrogen maleate, isooctyl hydrogen maleate, cyclobutyl hydrogen maleate, cyclopentyl hydrogen maleate, cyclohexyl hydrogen maleate, 3,3,5-trimethylcyclohexyl hydrogen maleate, 1-isopropyl-4-methylcyclohexyl hydrogen maleate, ethenyl hydrogen maleate, isopropenyl hydrogen maleate, allyl hydrogen maleate, 3-hexenyl hydrogen maleate, 3-cyclohexenyl hydrogen maleate, 3,5,5-trimethyl-2-cyclohexenyl hydrogen maleate, phenyl hydrogen maleate, benzyl hydrogen maleate, naphthyl hydrogen maleate, 4-t-butylphenyl hydrogen maleate, 4-vinylphenyl hydrogen maleate, methyl hydrogen acetylenedioate, ethyl hydrogen acetylenedioate, 2,2,2-trifluoroethyl hydrogen acetylenedioate, isopropyl hydrogen acetylenedioate, 2-ethylhexyl hydrogen acetylenedioate, cyclopentyl hydrogen acetylenedioate, 3,3,5-trimethylcyclohexyl hydrogen acetylenedioate, ethenyl hydrogen acetylenedioate, allyl hydrogen acetylenedioate, phenyl hydrogen acetylenedioate, naphthyl hydrogen acetylenedioate, and 4-t-butylphenyl hydrogen acetylenedioate.

Examples of monoamides of unsaturated aliphatic 1,4-dicarboxylic acids that are useful as inhibitors are N-methylmaleamic acid, N,N-dimethylmaleamic acid, N-ethylmaleamic acid, N-2,2,2-trifluoroethylmaleamic acid, N,N-diethyl maleamic acid, N-propylmaleamic acid, N-butylmaleamic acid, N,N-bis(2-ethylhexyl)maleamic acid, N-cyclopentylmaleamic acid, N-pentamethylenemaleamic acid, N-allylmaleamic acid, N-phenylmaleamic acid, N-methylcarbamoylpropiolic acid, N,N-dimethylcarbamoylpropiolic acid, N-ethylcarbamoylpropiolic acid, N-(2-ethylhexyl)carbamoylpropiolic acid, N-cyclohexylcarbamoylpropiolic acid, N-allylcarbamoylpropiolic acid, N,N-diallylcarbamoylpropiolic acid, N,N-diphenylcarbamoylpropiolic acid, and N-tetramethylenecarbamoylpropiolic acid.

Useful salt inhibitors are disclosed in U.S. Pat. No. 3,461,185 and include tetramethyl guanidine carboxylates such as tetramethylguanidine acetate, tetramethyl guanidine propionate, tetramethyl guanidine butyrate, tetramethyl guanidine valerate, tetramethyl guanidine caproate, tetramethyl guanidine enanthate, tetramethyl guanidine caprylate, tetramethyl guanidine pelargonate, tetramethyl guanidine caprate, tetramethyl guanidine hendecanoate, tetramethyl guanidine laurate, tetramethyl guanidine tridecanoate, tetramethyl guanidine myristate, tetramethyl guanidine pentadecanoate, tetramethyl guanidine palmitate, tetramethyl guanidine trifluoroacetate, tetramethyl guanidine margarate, and tetramethyl guanidine stearate.

Particularly useful inhibitors for the compositions of this invention are the maleates and alkynyl alcohols.

The inhibitor may be added to the polysiloxane adhesion promoting additive in an amount of from about 0.1% to about 3% by weight, based on the weight of the polysiloxane. In one embodiment, the inhibitor is added in an amount of from about 0.5% to about 1% by weight.

### EXAMPLES

### Example 1

### Preparation of Anchorage Additive

A mixture of allyl glycidyl ether (AGE) (Aldrich, 2.886 g, 25.3 mmol) and polymethylhydrosiloxane (2.97 g, SiH=47.5 mmol) is diluted with toluene (50 mL) and stirred with 0.61×10⁻⁴ ppm platinum at room temperature. A small exothermic effect is observed after about 10 min. Progress of the reaction is followed by ¹H NMR—after 1 hr 25% of Si—H groups are converted to Si—C bonds. In order to increase conversion of Si—H bonds, the mixture is stirred further for additional 24 hrs. Toluene is evaporated. An inhibitor, 3,5-dimethyl-1-hexyn-3-ol, is added to the polysiloxane in amount of 1% by weight.

### Example 2

### Preparation of Anchorage Additive

A mixture of allyl glycidyl ether (AGE) (Aldrich, 142.7 g, 1.25 mol) and polymethylhydrosiloxane (150.0 g, SiH=1.6 wt %) and 20 ppm ethanol solution of tris(dibutylsulfide)rhodium(III)trichloride containing 1.2 wt % rhodium at 120-130° C. after an exotherm to 170° C. for 4 hours. The reaction mixture is filtered then vacuum stripped at 120° C. An inhibitor, 2-methyl-3-butyn-2-ol, is added to the polysiloxane in amount of 1% by weight.

### Example 3

### Preparation of Anchorage Additives

### Additive A

A mixture of allyl glycidyl ether (AGE) (Aldrich, 79.1 g, 0.69 mol) and polydimethylmethylhydrosiloxane (200.0 g, SiH=1.05 wt %) and 20 ppm rhodium using an ethanol solution of tris(dibutylsulfide)rhodium(III)-trichloride containing 1.2 wt % rhodium at 95-120° C., then held at 95-120° C. for 1 hour. The reaction mixture is vacuum stripped at 120° C. An inhibitor, diallyl maleate, is added to the polysiloxane in amount of 1% by weight.

### Additive B

A mixture of allyl glycidyl ether (AGE) (Aldrich, 89.8 g, 0.79 mol) and polydimethylmethylhydrosiloxane (150.0 g, SiH=1.05 wt %) and 20 ppm rhodium using an ethanol solution of tris(dibutylsulfide)rhodium(III)trichloride containing 1.2 wt % rhodium at 95-120° C. then held at 95-120° C. for 1 hour. The reaction mixture is vacuum stripped at 120° C. An inhibitor, 1-ethynyl-cyclohexanol, is added to the polysiloxane in amount of 1% by weight.

### Additive C

A mixture of allyl glycidyl ether (AGE) (Aldrich, 66.2 g, 0.58 mol) and polymethylhydrosiloxane (145.0 g, SiH=1.6 wt %) and vinyltrimethoxysilane (86.0 g, 0.58 mol) and 20 ppm rhodium using an ethanol solution of tris(dibutylsulfide)rhodium(III)trichloride containing 1.2 wt % rhodium at 95-145° C. then held at 95-110° C. for 2 hours. An inhibitor, 3,5-dimethyl-1-hexyn-3-ol, is added to the polysiloxane in amount of 1% by weight. An inhibitor, 3,5-dimethyl-1-hexyn-3-ol, is added to the polysiloxane in amount of 1% by weight.

### Example 4

An inhibitor is added to AnchorSil 2000, an adhesion promoting additive commercially available from General Electric, in the amounts shown (weight %, based on the weight of the AnchorSil 2000) in Table 1 below. The stability of the adhesion promoting additive is determined by the time it takes for the additive to gel. The failure mode is characterized by a viscosity increase, accompanied by a random bubble formation at the fluid surface, believed to be H₂ evolution. Brookfield viscosity is recorded for the initial measurement.

TABLE 1

| Experiment | Initial (cps) | 2 Weeks | 1 Month | 2 Months | 3 Months | 4 Months |
|---|---|---|---|---|---|---|
| Control | 217 | o.k. | Gelled | — | — | — |
| 0.5% DAM¹ | 210 | Gelled | — | — | — | — |
| 1.0% DAM | 204 | o.k. | Gelled | — | — | — |
| 0.5% ECH² | 205 | o.k. | o.k. | Gelled | — | — |
| 1.0% ECH | 196 | o.k. | o.k. | Gelled | — | — |
| 0.5% S-61³ | 200 | o.k. | o.k. | o.k. | Gelled | — |
| 1.0% S-61 | 191 | o.k. | o.k. | o.k. | o.k. | Gelled |
| 0.5% MB⁴ | 211 | o.k. | o.k. | o.k. | Gelled | — |
| 1.0% MB | 196 | o.k. | o.k. | o.k. | o.k. | Gelled |

¹Diallyl maleate
²1-Ethynyl-cyclohexanol
³3,5-Dimethyl-1-hexyn-3-ol
⁴2-Methyl-3-butyn-2-ol

The stabilized adhesion promoting additive may be added to a curable silicone release composition. The silicone release composition may comprise an alkenyl substituted polysiloxane base polymer, a hydride functional crosslinking siloxane polymer, an addition cure hydrosilylation catalyst and a cure inhibiting compound.

The curable silicone release composition containing the stabilized adhesion promoting additive may be coated on a substrate to form a release liner. The substrate may be paper or a polymeric film such as polyester, polyethylene and polypropylene.

While the invention has been explained in relation to its preferred embodiments, it is to be understood that various modifications thereof will become apparent to those skilled in the art upon reading the specification. Therefore, it is to be understood that the invention disclosed herein is intended to cover such modifications as fall within the scope of the appended claims.

1. An adhesion promoting additive for curable silicone release coatings, the additive comprising (a) a polysiloxane having the formula (RₐSiO_{(4-a)/2})ₙ where n is an integer greater than 3, a is from 1 to 3, R is an epoxide containing radical having from one to forty carbon atoms, monovalent hydrocarbon or hydrocarbonoxy radicals, hydride atoms, and with at least one epoxide and hydride being present on the molecule; and (b) a storage stabilizer comprising an inhibitor, wherein the additive exhibits improved storage stability.

2. The adhesion promoting additive of claim 1 wherein the inhibitor is chosen from alkynyl alcohols or unsaturated hydrocarbon diestars.

3. The adhesion promoting additive of claim 1 wherein the inhibitor comprises 3,5-dimethyl-1-hexyn-3-ol.

4. The adhesion promoting additive of claim 1 wherein the inhibitor comprises diallyl maleate.

5. The adhesion promoting additive of claim 1 wherein the inhibitor is present in an amount from about 0.1% to about 3% by weight, based on the weight of the polysiloxane.

6. The adhesion promoting additive of claim 1 wherein the inhibitor is present in an amount from about 0.5% to about 1% by weight, based on the weight of the polysiloxane.

7. The adhesion promoting additive of claim 1 wherein the polysiloxane comprises γ-glycidoxypropyl triethoxysilane.

8. A release composition comprising the adhesion promoting additive of claim 1.

9. A release liner comprising a substrate and a curable release composition coated thereon, the curable release composition comprising the adhesion promoting additive of claim 1.

10. The release liner of claim 9 wherein the substrate comprises polyester.

11. A method of making a storage stable adhesion promoting additive for curable silicone release coatings comprising (a) providing adhesion promoting polysiloxane having the formula (RaSiO_{(4-a)/2})ₙ where n is an integer greater than 3, a is from 1 to 3, R is an epoxide containing radical having from one to forty carbon atoms, monovalent hydrocarbon or hydrocarbonoxy radicals, hydride atoms, and with at least one epoxide and hydride being present on the molecule; and (b) adding a storage stabilizer comprising an inhibitor to the polysiloxane, wherein the additive exhibits improved storage stability.

12. The method of claim 11 wherein the inhibitor is chosen from alkynyl alcohols or unsaturated hydrocarbon diesters.

13. The method of claim 11 wherein the inhibitor comprises 3,5-dimethyl-1-hexyn-3-ol.

14. The method of claim 11 wherein the inhibitor comprises diallyl maleate.

15. The method of claim 11 wherein the inhibitor is added in an amount from about 0.1% to about 3% by weight, based on the weight of the polysiloxane.
